(19) United States
(12) Patent Application Publication
(10) Pub. No.: US 2026/0087947 A1
(43) Pub. Date: Mar. 26, 2026

(54) SYSTEM AND METHOD FOR PROVIDING RETRIEVABLE ARTWORK DETAILS THROUGH INTERCHANGEABLE PLACARDS

(71) Applicant: Arthur Theodore Grayson, III, Laurel, MD (US)

(72) Inventor: Arthur Theodore Grayson, III, Laurel, MD (US)

(21) Appl. No.: 19/337,150

(22) Filed: Sep. 23, 2025

Related U.S. Application Data
(60) Provisional application No. 63/697,900, filed on Sep. 23, 2024.

(51) Int. Cl. G09F 3/00

(52) U.S. Cl. CPC G09F 3/0297

(57) ABSTRACT

A placard system and method for providing artwork details for artwork displays which are interchangeable. The placard system and method utilizes physical placards and employs an approach wherein a collection of static information specific to a physical placard and dynamic information which relates to a displayed artwork item are managed by an administrator computer system to allow artwork information to be retrieved when desired on a user device by entering the static information on the user device. The physical placard may be installed on site in direct proximity to an artwork piece that is on display that it is associated with. The static information may be unique placard numbers and machine-readable codes. The dynamic information has data and details which are specific to the piece. Thus, when a piece is moved or replaced in a given exhibit, any association between static information and dynamic information may be changed on demand.

### CROSS REFERENCE TO RELATED APPLICATIONS

This application claims the benefit of and incorporates by reference co-pending U.S. provisional patent application Ser. No. 63/697,900 filed Sep. 23, 2024.

### BACKGROUND OF THE INVENTION

### Field of the Invention

The present disclosure relates to labeling systems involving written or printed information, and, more particularly, to a labeling system and method which allows fixed placards to dynamically facilitate the retrieval of information relating to interchangeable artwork displays.

### Description of the Prior Art

Existing methods of informational labeling, pricing, and purchase of artworks are rife with inconsistencies of practice. The pains of this problem in the visual arts industry are felt most when the artworks of emerging artists are exhibited and sold by boutique galleries and underfunded public arts organizations where workforce and resources are severely limited. Drafting, printing, and installing labels matched to specific artworks for a given exhibition or art fair, that must afterwards be removed and replaced with all new labels for subsequent shows, exacts a heavy toll on small arts businesses (“SABs”). Common solutions such as handwritten labels, typed labels, and color coded stickers such as the iconic red dots have been used by many SABs, but this shortcoming pervades them all.

Moreover, delays caused by emerging artists delivering artworks for installation late, or setbacks caused by SABs keeping inconsistent records, severely limit the ability to produce a professional exhibition. This is because in almost all instances, artwork display labels cannot be drafted, printed and installed until after the artworks are delivered to the venue and the information of the artworks is recorded by the SAB. Compounding the problem are a multiplicity of variables for which all of the aforementioned common solutions do not scale up efficiently. Issues such as the large venue size of some SABs, a large number of artworks in a show, and the multiplicity of disciplines and mediums in the visual arts industry (e.g. painting, drawing, pyrography, sculpture, claywork, fabric arts, performance arts, photography, videography, etc.) have made it impractical and undesirable for people to enjoy learning about art, as well as for SABs to verify the information of artworks, and for exhibitors to update the displayed information about artworks as the works themselves change, show to show.

Attempts have been made to innovate solutions for accessing information about artworks, but lacked a direct applicability that offers a scalable solution for SAB's exhibition installations. For example, U.S. Pat. No. 6,896,520 claims to provide a novel system and method for encouraging an understanding of visual art, devising a set of dual sided collectable cards with artwork information and iconographic signifiers for identifying artworks by specific artists as an educational tool. This simplified system, however, is built for education and for enjoyment lacks a means for updating artwork details dynamically. Furthermore, it could not be used for display purposes in SABs.

US Patent Application Publication No. US20070247317 purports to disclose a method and apparatus for ownership authenticity of artworks using RFID tags attached to the backsides of artworks. Unfortunately, while this disclosure may be an inexpensive solution for art businesses, it may lack the capability to provide for transferability from one artwork to another.

Chinese Patent CN207381053U purports to disclose a wall-mounted apparatus as a fixed base with an opening window for the user to exchange the display cards presented within the opening window according to the changing exhibition or presentation. An approach like this however, may result in the cost of such an apparatus being a drawback for SABs, as would the need to pre-order display cards precisely fitting the display window of the fixed base in advance of the show, stymying a timely deployment of updated exhibition cards on short notice.

Accordingly, there remains a need for a system and method which may overcome the shortcomings of prior art by utilizing placards which enabling SABs to rapidly deploy labeling for artworks in a manner which saves time, reduces waste, improves the production of art exhibitions, art fairs, and gallery or studio displays, and otherwise resolves inconsistencies of practice rife in the visual arts industry. It would be desirable for such a system and method to provide artwork display labels that can be obtained in advance, and for which any unique display label can be assigned at a moment's notice to any given artwork display in the show and then reassigned for reuse when desired.

### SUMMARY OF THE INVENTION

The present disclosure provides for a system and method for providing information through physical placards for artwork displays which are interchangeable, with the method comprising the steps of: providing displayed item information relating to an item being exhibited; generating by an administrator computer system placard information, wherein said placard information is operative to be input into a user computer; causing said placard information to be displayed in a physical location which is adjacent to said first item being exhibited; and associating by said administrator computer system said displayed item information and said placard information such that entering said placard information into said user computer causes said user computer to retrieve said displayed item information.

Embodiments of the method for providing information through physical placards for artwork displays which are interchangeable may additionally include the step of producing a physical placard plate containing said placard information, wherein the step of producing is performed before the step of causing said placard information to be displayed.

It is an object of the present disclosure to provide a placard system and method for providing artwork details which utilizes artwork display labels that can be obtained in advance.

It is an additional object of the present disclosure to provide a placard system and method for providing artwork details which allows any unique display label to be assigned at a moment's notice to any unique artwork in a show.

It is an additional object of the present disclosure to provide a placard system and method for providing artwork details which allows any unique display label that has been previously used to be reassigned for reuse at a later time.

### BRIEF DESCRIPTION OF THE DRAWINGS

FIG. 1 is a front elevational view of a placard plate for a placard system and method for providing artwork details built in accordance with the present disclosure.

FIG. 2 is a schematic diagram showing the flow of an assigning process for a placard system and method for providing artwork details built in accordance with the present disclosure.

FIG. 3 is a flow chart showing an assigning and reassigning process for a placard system and method for providing artwork details built in accordance with the present disclosure.

FIG. 4 is a schematic diagram showing the flow of a retrieving process for a placard system and method for providing artwork details built in accordance with the present disclosure.

FIG. 5 is a front elevational view of placard plate for a placard system and method for providing artwork details built in accordance with the present disclosure, shown in place in a first exemplary exhibit.

FIG. 6 is a front elevational view of placard plate for a placard system and method for providing artwork details built in accordance with the present disclosure, shown in place in a second exemplary exhibit.

### DETAILED DESCRIPTION OF THE INVENTION

Described herein is a placard system and method for providing artwork details for artwork displays which are interchangeable. A placard system and method for displaying artwork details in accordance with the present disclosure utilizes physical placards and employs an approach whereby two sets of information—one set that is static and one set that is dynamic—can be managed to allow artwork information to be retrieved when desired using matter which is displayed on the physical placard. The static information is displayed on the physical placard and does not change once generated. This static information may be unique placard numbers and machine-readable codes. The dynamic information has data and details which may change on demand and may comprise a plurality of artwork information. The physical placard may be installed on site in direct proximity to an artwork piece that is on display that it is associated with. The dynamic information is represented by certain details for given artwork pieces and may be retrieved using the static information.

It is contemplated that the dynamic information may be stored by the SAB in their preferred computer system for storing information regarding pieces of artwork when receiving such artwork (such as creator, title, date of creation, etc.).

Retrieving the dynamic information for a given artwork piece where the artwork is displayed may be achieved by searching the static information. In accordance with the present invention, this static information may be visually presented on the physical surface of a physical placard apparatus, commonly referred to as a “placard plate,” which is placed adjacent to the artwork being displayed. The dynamic information desired to be retrieved may be stored as an entry in an artwork database in a computer system, or part of a computer system, controlled by the SAB who is displaying the artwork. Such dynamic information may be stored by the computer system in a manner which allows it to be accessed using an Internet Protocol (IP) address, uniform resource locator (URL), or other suitable method for making information available for retrieval over the Internet or other computer network (such as a webpage). The static information on the placard plate may also be associated with an IP address, URL or other suitable designation in a manner which allows it to operate as a pointer which directs traffic to the location where the dynamic information may be accessed, or otherwise allows for the display of information from the database entry.

It is appreciated that the details of any IP address, URL or other suitable designation with which the static information is associated with can be updated on demand, such that a location the static information points to can be reassigned to any destination IP, URL or otherwise so as to be able to be coupled with any registered artwork in the SAB's database. In this regard, the present disclosure may also incorporate the use of a placard plate entries in its database for storing the static information of placards. These entries can then be selectively coupled with a database entry for a given artwork piece. Accordingly, when a placard number is searched the database, or when a gallery visitor scans a machine-readable code on the placard plate with their preferred device, the information immediately retrieved is the associated registered information of the artwork in direct proximity to which the placard plate is installed.

The present disclosure additionally provides for an SAB reassigning the placard number to a different artwork by repointing the static information to different dynamic information entry when desired, upon which utilizing the static information on a given placard plate will direct one who searched or scanned the given placard to the information of different artwork piece. This allows the placard plate to remain in place while the artwork in proximity to which it is installed changes, or for the artwork to remain in place while a placard plate is moved to a location beside a different artwork piece. This also allows SABs whose preferred artwork database system includes e-commerce sales to use placard plates to enable or facilitate a point of sale transactions wherein the SAB's preferred system stores as dynamic information both the registered information about the artwork as well as its price and an e-commerce checkout gateway, the IP or URL leading to such payment information. In this regard, in addition to allowing for the retrieval of artwork information by searching the placard number or scanning the placard plate, a placard plate may help facilitate purchasing of artwork (as well as ensuring items cannot be purchased once already so, and enabling bidding in auction style sales).

Commercially positive aspects of the present disclosure include being fast and easy to implement as well as the placard plate itself being visually simple and uncomplicated and cheap to mass produce. An example of use includes, but is not limited to, an SAB ordering placard plates in advance of artwork arriving at the SAB's venue, installing the artwork, assigning an interchangeable placard to each artwork when desired and in any order; when viewed by a visitor of the venue, the placard plate could be scanned by the visitor's mobile device, displaying the artwork information, price, and payment details on the mobile device, enabling the visitor to purchase. In this regard, a robust and efficient way to accomplish informational labeling, pricing, and sale of artworks may be achieved.

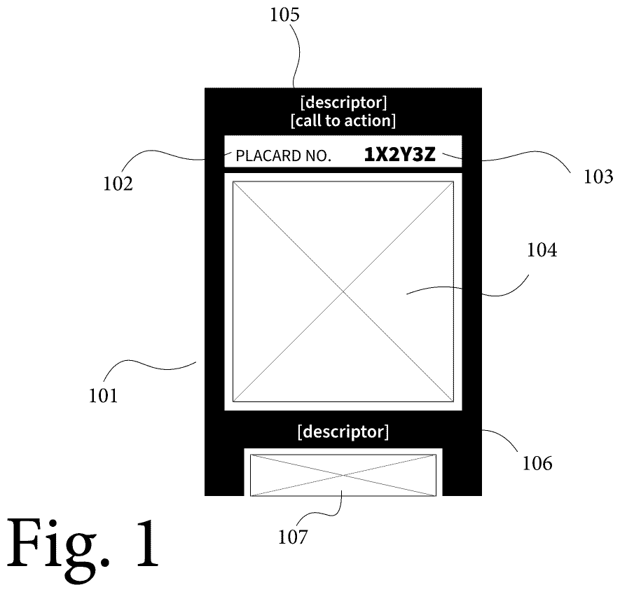

Referring now to the drawings and, in particular, FIG. 1, a placard plate may be defined as a plate member 101 containing a unique number field 102 with a human-readable identifier 103, such as a six-digit alphanumeric number below which is a unique code field for a machine-readable identifier 104, which, without limitation, may be embodied as a two-dimensional code and/or three-dimensional coded device. Embodiments of the plate member 101 may comprise a monochrome [HEX #000000 & HEX #FFFFFF] plate sized at 171 pixels×252 pixels, with the unique number field 102 sized at 146.4 pixel×19.5 pixels, a six-digit alphanumeric number sized at 13.5 pt. A two-dimensional code may be implemented as a quick response code (“QRC”), while a three-dimensional coded device may be implemented as a radio frequency identification tag or near field communication chip.

Below the machine-readable identifier 104, the plate member 101 may contain enough space for a descriptive message 106 and an image field 107. In some embodiments of the present disclosure, the image field 107 may be used to allow for sponsorship messages or a logo from a company licensing. The placard plate may also have a header space 105 for another descriptive message or call to action. In embodiments of the present disclosure, the descriptive message 106 may be sized at 11.3 pt, the image field 107 may be sized at 122.3 pixels×X 29.3 pixels, and header space 105 may be used for a descriptive message or call to action sized at 11.3 pt.

A given plate member 101 forming a placard plate may be created (potentially by a graphic designer or a software program) with the static information unpopulated in the unique number field 102 and the machine-readable identifier 104. Once the static information is created, it may in some embodiments be exported with the visual characteristics prescribed and in the hierarchical arrangement described—or other combinations or orientations desired without limiting or altering the functions defined in the present disclosure—to produce a series of design files which are each unique, and in one such embodiment can be conveyed in physical form for interaction (e.g. scanning) by being printed on a material such as but not limited to paper, vinyl, foam board, pvc, wood, plastic, etc., and with or without an adhesive backing for mounting to a wall.

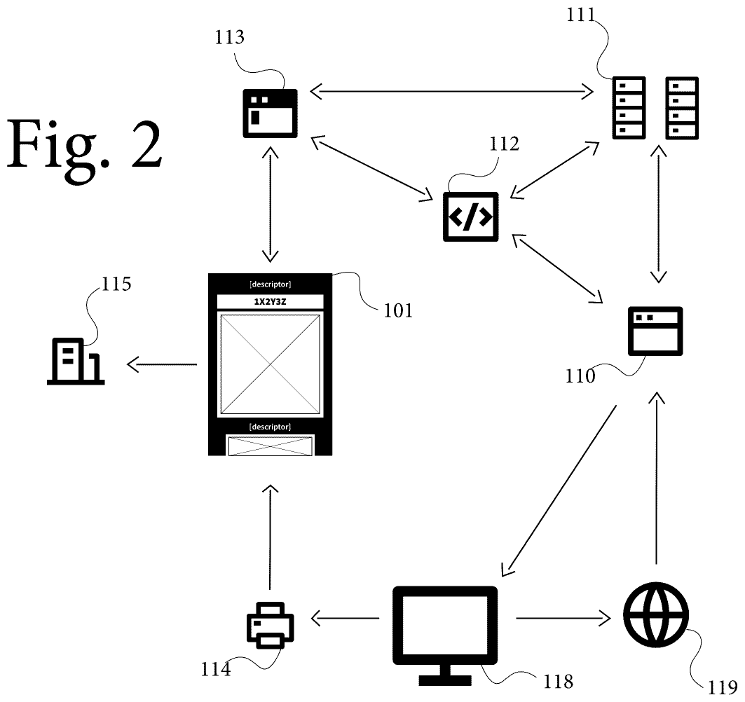

Referring now to FIGS. 1 and 2, a system which allows for the displaying of artwork details using interchangeable placards may assign artwork information utilizing a software application 112, a database 111, a frontend web application 110 (i.e., a user interface), a backend web application 113 (i.e., an admin panel), a network connection 119, such as an Internet connection, a computer 118, a site of installation 115, and a printer 114. A computer 118 is used for accessing a software application 112 to upload artwork information via a frontend web application 10 so that it can be stored in a database 111. In order to create and print a plate member 101 exported by the backend web application 113, the software application 112 may generate a random and unique human-readable identifier 103 using only letters and numbers (e.g. “1X2Y3Z”), and pairs it with a unique machine-readable code 104, such as a QRC. The human-readable identifier 103, which is also stored in the database 111, and machine-readable code 104 are unique to all previously generated codes and identifiers, but they are paired by first generating the human-readable identifier 103, then generating the machine-readable code 104 as a visual representation of the identifier populated in the frontend web application's 110 URL path, e.g.

### https://website.com/placard/1x2y3z

The URL path may also be stored as an entry in the database 111. This ensures the human-readable identifier 103 and the machine-readable code 104 are each unique and can reliably retrieve identical information when searched. Once this static information is stored in the database 111, the software application 112 can manage a link between the static placard information and dynamic artwork information, while the backend web application 113 generates the visual image of the placard with human-readable identifier 103 and machine-readable code 104 populated in their respective fields. The frontend web application 110 returns this visual image of the placard to the computer 118 to be exported to the printer 114 to be printed as a physical placard plate, and installation on site 115.

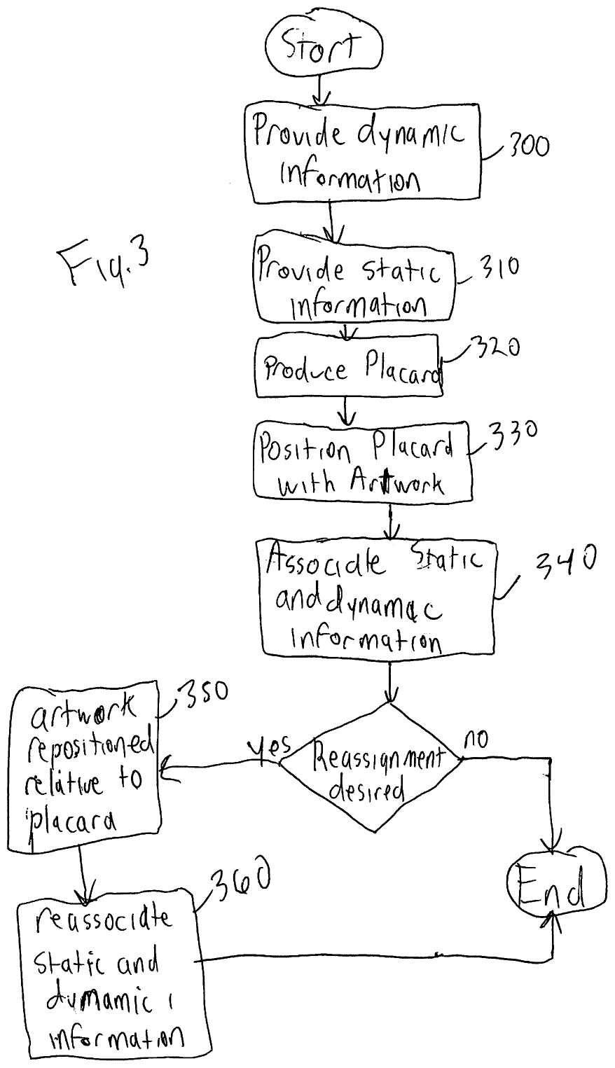

Referring now to FIG. 3, the assigning of a placard in accordance with the present disclosure may begin with the provision of information about a displayed item, such as a first artwork piece at step 300. Such information may be defined as dynamic information relative to the placard system because it is not fixedly associated with any physical placard. Next, the information about a given physical placard must be provided at step 310. It is appreciated that providing this information, which may be considered static relative to a given physical placard because it will not change for a physical placard, may be done by generating such information by an administrator computer system, such as the computer 108 referred to in FIG. 1.

Once the displayed item information for the first piece of art and the placard information is provided, a physical placard may be produced at step 320 and then positioned next to the first artwork piece at step 330. This demonstrates a scenario where placard production occurs in series, following the availability of displayed item information and placard information, resulting in a placard produced with an existing association. In some embodiments, the production of the physical placard may occur in parallel with, or prior to, the provision of the displayed item information. For example, a large number of placards can be generated, printed, and distributed in advance, allowing a SAB to select and use a placard as needed.

Once a physical placard is in position, the displayed item information for the first piece of art and the placard information may be associated in the administrator computer system at step 340 such that the displayed item information for the first piece of art can be retrieved on a discrete user device through the entry of the placard information on the user device. Once this is complete, the assignment of a placard to the first artwork piece is complete unless and until it is desired to reassign the placard to a second piece of art.

It may be desired to reassign the placard to a second piece of art if the first artwork piece is moved or removed from the location next to the physical placard and the second piece of art is positioned next to the physical placard at step 350. Following this, the displayed item information for the second piece of art and the placard information must be associated (and the association between the displayed item information for the first piece of art and the placard information must be broken) in the administrator computer system at step 360 such that the displayed item information for the second piece of art can be retrieved through the entry of the placard information. At that point, the assignment of a placard to the second artwork piece is complete.

It is contemplated, however, that a reassignment of a placard to a different artwork may occur without the physical movement of either the placard or the artwork. For instance, if an SAB determines that two placards have been erroneously assigned to two artworks such that each placard refers to the other (e.g., placard 1 assigned to artwork A and placard 2 assigned to artwork B, when the intended assignment was placard 1 to artwork B and placard 2 to artwork A), the system allows for the direct modification of these associations. A user may scan the first placard intended for reassignment, select the desired artwork for that placard, and the system will overwrite the existing assignment with the new one. This process may result in an artwork having multiple placards assigned to it, which is contemplated within the scope of the present system (e.g., to facilitate access in large exhibition spaces). Subsequently, the user may scan the other placard and assign the first artwork that was left unassigned. This method enables the correct association of both placards with their respective artworks in fewer steps, by directly modifying the digital associations within the administrator computer system, thereby obviating the need for physical relocation of either the artwork or the placards

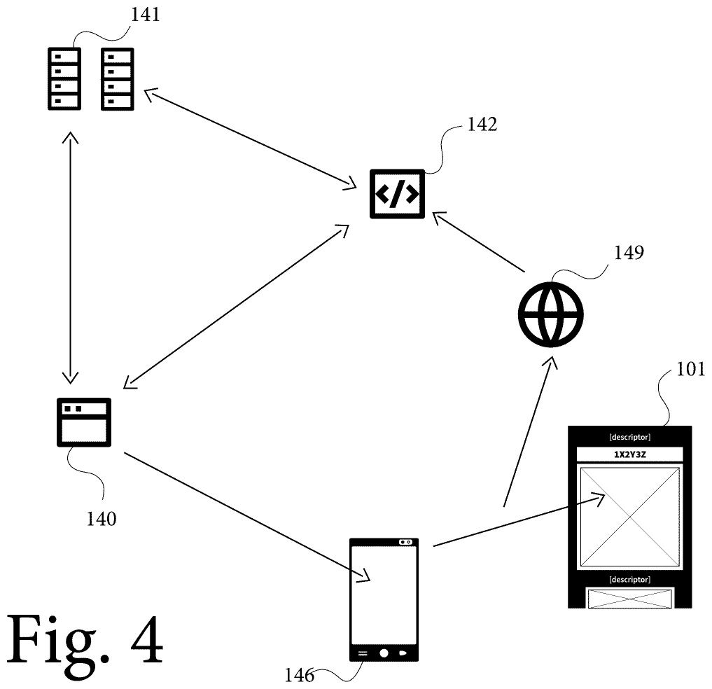

Referring now to FIGS. 1 and 4, a system which allows for the displaying of artwork details using interchangeable placards may retrieve artwork information by utilizing a smartphone 146 (or other computer), the plate member 101, a network connection 149, a software application 142, a database 141, and a frontend web application 140. A smartphone 146 may be used to scan a QRC on a plate member 101 and then be triggered by the smartphone's 146 internal operating system software to browse the Internet searching for the static placard information (URL and placard number) encoded in the QRC. Upon reaching the URL, the software application 142 managing the relationship between the data stored in the database 141, points the user using the static placard information to the destination URL where the dynamic artwork information can be served onto a frontend web application 140 on the user's smartphone web browser.

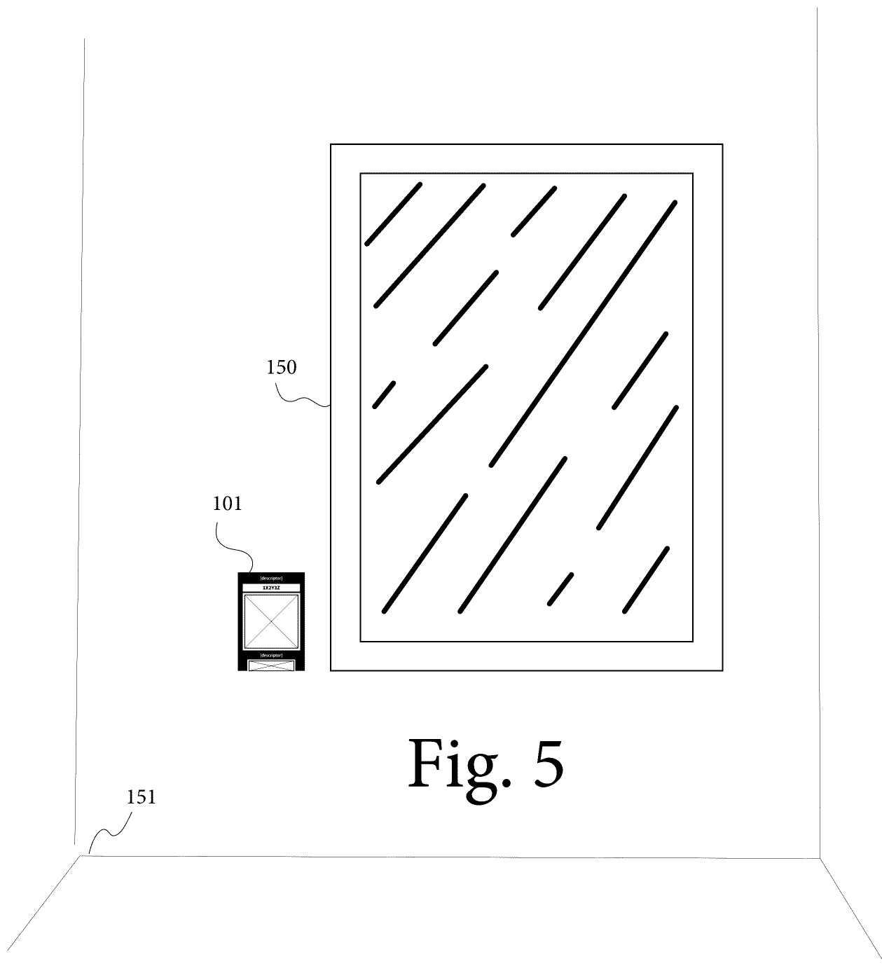

Referring now to FIGS. 1 and 5, a placard plate defined by a plate member 101 may be employed in a location that is in direct proximity to artwork 150 for which it was assigned as the display label on a wall of a room of an exhibition 151.

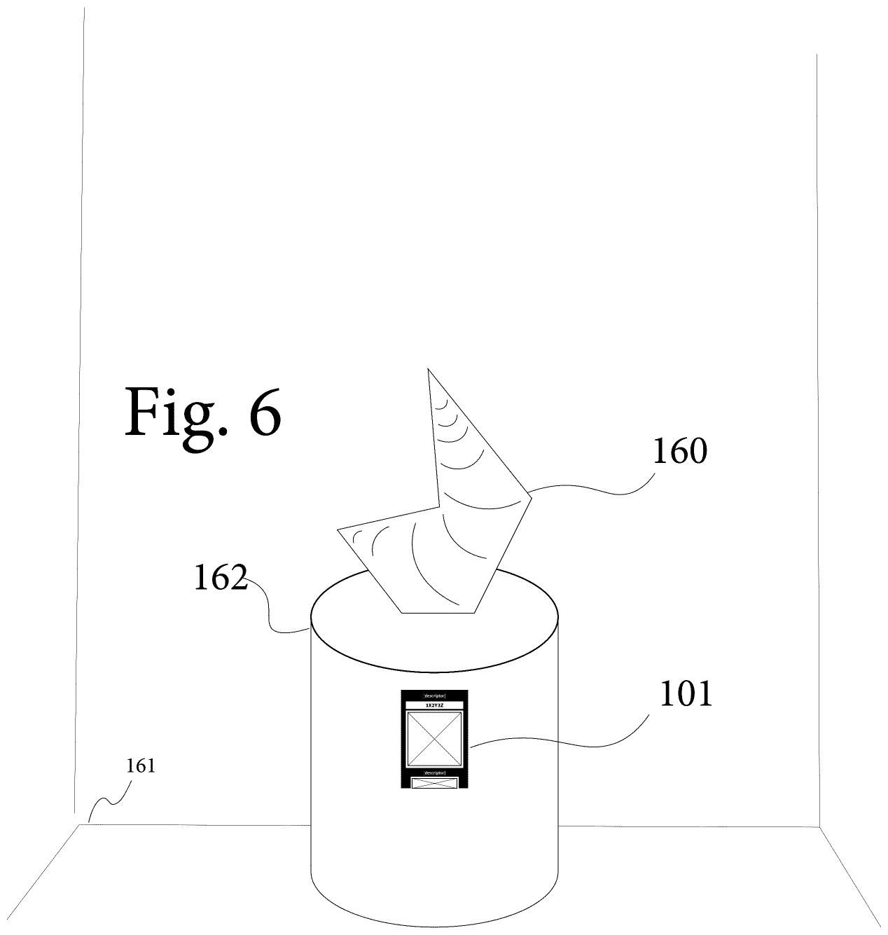

Referring now to FIGS. 1 and 6, a placard plate defined by a plate member 101 similar to that shown in FIG. 4 may be subsequently reinstalled on a plinth 162 in the same room of an exhibition 161, with placard plate 101 having been reassigned to a new artwork 160 on display.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for providing information through physical placards for artwork displays which are interchangeable, comprising the steps of:
providing displayed item information relating to an item being exhibited;
providing placard information, wherein said placard information is operative to be input into a user computer;
causing said placard information to be displayed in a physical location which is adjacent to said first item being exhibited; and
associating by an administrator computer system said displayed item information and said placard information such that entering said placard information into said user computer causes said user computer to retrieve said displayed item information.

2. The method of claim 1, wherein said displayed item information includes at least one of a title information and a creator information for said item being exhibited.

3. The method of claim 1, wherein said placard information includes at least one of a human-readable identifier and a machine-readable identifier.

4. The method of claim 1, wherein said placard information includes a human-readable identifier and a machine-readable identifier.

5. The method of claim 4, wherein said machine-readable identifier is generated from said human-readable identifier.

6. The method of claim 1, wherein said user computer defined by a smartphone.

7. The method of claim 1, additionally comprising the step of producing a physical placard plate containing said placard information, wherein the step of producing is performed before the step of causing said placard information to be displayed.

8. A method for providing information through physical placards for artwork displays which are interchangeable, comprising the steps of:
providing displayed item information relating to an item being exhibited;
generating by an administrator computer system placard information, wherein said placard information is operative to be input into a user computer;
causing said placard information to be displayed in a physical location which is adjacent to said first item being exhibited; and
associating by said administrator computer system said displayed item information and said placard information such that entering said placard information into said user computer causes said user computer to retrieve said displayed item information.

9. The method of claim 8, additionally comprising the step of producing a physical placard plate containing said placard information, wherein the step of producing is performed before the step of causing said placard information to be displayed.

10. The method of claim 9, wherein said displayed item information includes at least one of a title information and a creator information for said item being exhibited.

11. The method of claim 10, wherein said placard information includes a human-readable identifier and a machine-readable identifier.

12. The method of claim 11, wherein said machine-readable identifier is generated from said human-readable identifier.

13. The method of claim 8, wherein said placard information includes at least one of a human-readable identifier and a machine-readable identifier.

14. The method of claim 8, wherein said user computer defined by a smartphone.

15. A method for providing information through physical placards for artwork displays which are interchangeable, comprising the steps of:
providing a first item being exhibited and a second item being exhibited;
providing first displayed item information relating to said first item being exhibited and second displayed item information relating to said second item being exhibited;
providing placard information, wherein said placard information is operative to be input into a user computer;
causing said placard information to be displayed in a first physical location which is adjacent to said first item being exhibited;
following the step of causing said placard information to be displayed in a first physical location, associating by an administrator computer system said first displayed item information and said placard information such that entering said placard information into said user computer causes said user computer to retrieve said first displayed item information;
following the step of associating said first displayed item information, causing said placard information to be displayed in a second physical location which is adjacent to said second item being exhibited and said placard information to no longer be displayed in said first physical location; and
following the step of causing said placard information to be displayed in a second physical location, associating by an administrator computer system said second displayed item information and said placard information such that entering said placard information into said user computer causes said user computer to retrieve said second displayed item information.

16. The method of claim 15, additionally comprising the step of producing a physical placard plate containing said placard information, wherein the step of producing is performed before the step of causing said placard information to be displayed in a first physical location.

17. The method of claim 16, wherein said first displayed item information includes at least one of a title information and a creator information for said first item being exhibited and said second displayed item information includes at least one of a title information and a creator information for said second item being exhibited.

18. The method of claim 17, wherein said placard information includes a human-readable identifier and a machine-readable identifier.

19. The method of claim 18, wherein said machine-readable identifier is generated from said human-readable identifier.

20. The method of claim 15, wherein said user computer defined by a smartphone.
